(19) United States
(12) Patent Application Publication
(10) Pub. No.: US 2005/0182666 A1
(43) Pub. Date: Aug. 18, 2005

(54) Method and system for electronically routing and processing information

(76) Inventors: Timothy Patrick Jon Perry, Lynchburg, VA (US); Michael David Metzger, Lynchburg, VA (US); Diane M. Russell, Lynchburg, VA (US); Rajesh Rajaram Kadam, Avenel, NJ (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 10/777,634

(22) Filed: Feb. 13, 2004

(51) Int. Cl. G06F 17/60

(52) U.S. Cl. 705/4

(57) ABSTRACT

A method and system for routing and processing insurance related data. A data entry operator that receives insurance application-related documents from external sources. The data entry operator stores the documents electronically in a raw data database. A rules engine converts the documents into at least one data element having a common format. The rules engine then determines whether each of the at least one data element has been fully validated as clean data. If the data is verified, the clean data is stored in an operational database for use in application processing. If a data element is not clean, the rules engine generates an exception task. The rules engine then receives a resolution to the exception task, thereby enabling validation of the at least one data element.

### BACKGROUND OF THE INVENTION

The present invention is directed to a system for efficiently processing information originating from documents having various sources, types and formats. More specifically, the invention is directed to a method and system for facilitating document collection, analyses and processing functions associated with an insurance application process.

In conventional systems for processing insurance applications or various other types of applications, documents necessary to process the application are solicited and received from agents and other various data suppliers. Typical types of information may include paper or electronic applications, medical information, financial information, etc. Once received, the agents must manually review the information for completeness, requesting clarification and additional documentation where appropriate. Typically, each step in the application review/approval process must be completed in its entirety prior to advancing to a subsequent step.

Relating to the acquisition of data for such application processes, an initial application is typically received and reviewed for completeness and accuracy by a case handler. Upon review, information from the document would then be manually entered into a computer via the input controller of a particular computer. The original document would then filed away for future reference. Automatic input of data was limited to the input of Magnetic Ink Character Recognition (MICR) data and to Optical Character Recognition (OCR) data. This fixed-position data was forwarded directly to a dedicated computer application specifically designed to accommodate the input format. In more recent years, typewritten text has been mechanically inputted into a computer via a text file. Examples of this latter type of system are word processors and photo-typesetters.

These conventional systems have limitations which decrease the efficiency of processing information from a above are limited in their application to MICR, OCR, or typewritten data. Parsing and processing data is limited to the particular requirements of the particular computer application which requires the input data. In addition, in these conventional systems, the actual hard copy document must be retained for future reference at great expense.

Another problem, is that current systems can not efficiently accommodate the inputting of information from a diversity of hard copy documents. A large business which receives many forms in the same format can afford a system which inputs a high volume of information in that format into memory. For example, it is cost-effective for a bank which processes hundreds of thousands of checks a month to buy a dedicated machine which can read information off of checks having a rigidly defined, or fixed, format. However, as the diversity of forms received by a business increases relative to the number of forms that must be processed, it becomes less cost-effective to design a dedicated machine for processing each type of form format. It is frequently not cost-effective to design dedicated systems for inputting information in each of these various formats.

Accordingly there is a need in the art of data collection and processing for a system for enabling efficient processing of insurance applications utilizing a variety of stored documents and data types.

### BRIEF SUMMARY OF THE INVENTION

The present invention overcomes the problems noted above, and provides additional advantages, by providing a system for routing and processing insurance related data, the system comprising. Initially, a data entry operator that receives insurance application-related documents from external sources. The data entry operator stores the documents electronically in a raw data database. A rules engine is utilized to convert the documents into at least one data element having a common format. The rules engine then determines whether each of the at least one data element has been fully validated as clean data. If so, the clean data is stored in an operational database for use in application processing. However, if the data is not validated, the rules engine generates an exception task if it is determined that at least one data element is not clean. The rules engine then receives a resolution to the exception task, thereby enabling validation of the at least one data element.

According to another embodiment of the invention, a system is provided for routing and processing insurance related data, the system comprising. A data entry operator that receives insurance application-related documents from external sources. The data entry operator stores the documents electronically in a raw data database. A rules engine then converts the documents into at least one data element having a common format. The rules engine determines whether each of the at least one data element has been fully validated as clean data. The clean data is stored in an operational database for use in application processing. A state machine is provided that monitors clean data in the operational database and rules engine outputs. The state machine generates workflow tasks to enable case progression through the system, the tasks based upon said clean data and rules engine outputs. The state machine then receives responses to said workflow tasks, and determines case progression based upon said responses.

According to yet another embodiment of the invention, a method is provided for routing and processing insurance related data. Initially, insurance application-related documents is received from external sources. Next, the documents are stored electronically in a raw data database. A rules engine then converts the documents into at least one data element having a common format. It is then determined whether each of the at least one data element has been fully validated as clean data. Clean data in stored an operational database for use in application processing. An exception task is generated if it is determined that at least one data element is not clean. Resolution to the exception task are then received, thereby enabling validation of the at least one data element.

According to still another embodiment of the invention, a computer-readable medium incorporating instructions is provided for routing and processing insurance related data. One or more of the instructions are provided for receiving insurance application-related documents from external sources. One or more of the instructions are then provided for storing the documents electronically in a raw data database. One or more instructions are then provided for converting, by a rules engine, the documents into at least one data element having a common format. One or more instructions are provided for determining whether each of the at least one data element has been fully validated as clean data. One or more instructions are provided for storing clean data in an operational database for use in application processing. One or more instructions are provided for generating an exception task if it is determined that at least one data element is not clean. One or more instructions are then provided for receiving a resolution to the exception task, thereby enabling validation of the at least one data element.

### BRIEF DESCRIPTION OF THE DRAWINGS

The present invention can be more fully understood by reading the following detailed description together with the accompanying drawing, in which like reference indicators are used to designate like elements, and in which:

FIG. 1 is a generalized flow diagram showing the high level process in accordance with one aspect of the invention.

FIG. 2 is a flow diagram illustrating rules engine processing steps in accordance with one embodiment of the present invention.

FIG. 3 is a generalized block diagram illustrating an alternative view of the information routing and processing system of the present invention.

### DETAILED DESCRIPTION OF THE PREFERRED EMBODIMENTS

Hereinafter, aspects of a information routing and processing system in accordance with various embodiments of the invention will be described. As used herein, any term in the singular may be interpreted to be in the plural, and alternatively, any term in the plural may be interpreted to be in the singular. The various embodiments of the invention relate to systems and of processes for collecting, routing and processing data from a source of information, such as a paper document or other medium. The information will typically be entered into a computer system by a human being, who might be characterized as “data entry operator” (DEO), for example. Alternatively, information may be received and entered into the present system in an automated, entirely electronic manner, such as by EDI (electronic data interchange) or similar techniques. Exemplary types of information include: application information; medical information; physician's statements (typically stored as image data); lab results; EKG/ECG results (typically stored as image data); financial information; motor vehicle records; correspondence and ACORD XML feeds.

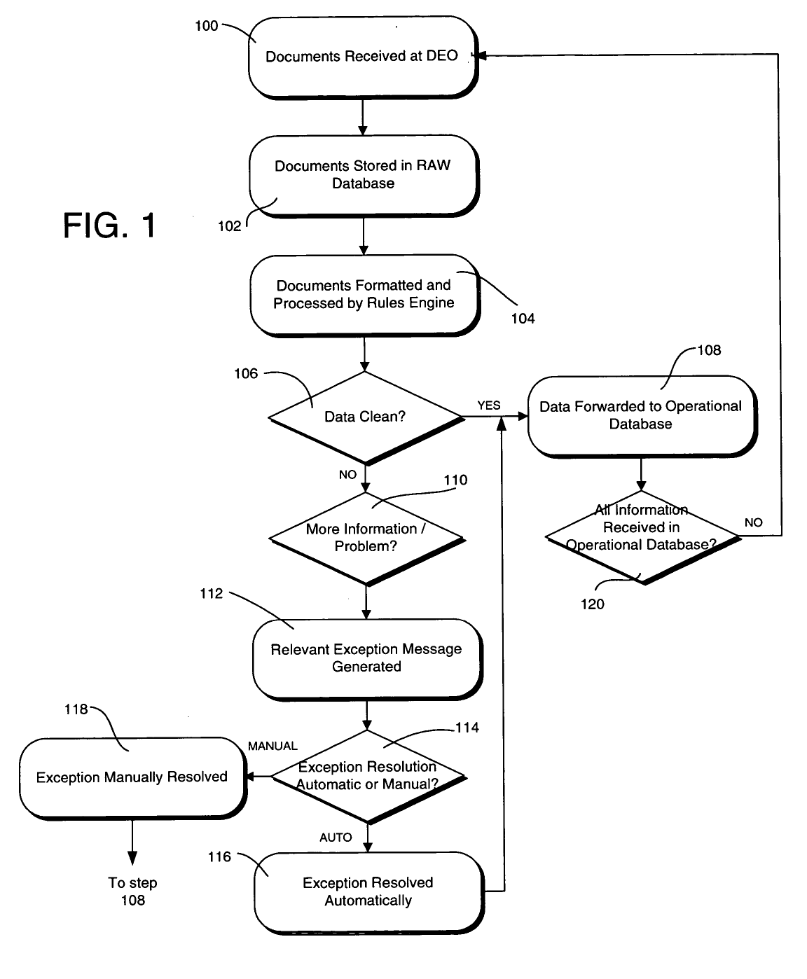

Referring now to FIG. 1, there is shown a generalized flow diagram illustrating one embodiment of the information routing and processing system of the present invention. Initially, a Data Entry Operator (DEO) facilitates the importation of various documents associated with the insurance application process in step 100, as briefly described above (e.g., application forms, medical records, lab results, etc.). The received documents are then preferably stored in a RAW data database in step 102, in a manner which preserves the native format in which the document was received. In most cases, “images” of the various documents will be stored. Alternatively, for electronic documents, these documents may be preserved and stored in their native electronic format (e.g., EDI, XML, DOC, etc.).

Once stored in the RAW database, the documents are then formatted and processing for content by a rules engine in step 104. In operation, the rules engine converts the raw data in the RAW database 102 into data having a generic format. In accordance with one embodiment of the present invention, the data is converted into XML (Extensible Markup Language), which facilitates usage by other processes. Additionally, by utilizing a single common format, it is not necessary to convert the data into a variety of different formats each time it moves through the different steps in the overall process. In an alternative embodiment of the present invention, multiple raw databases, each having different purposes are utilized to store received document data. One example of the utility of such a system includes circumstances in which different companies use a common core system as part of a “for fee” service or for enhanced security reasons.

In accordance with several embodiments of the present invention, data is not processed in a linear format as with some conventional information processing systems. Rather, data is processed as individual data elements using exceptions. In this manner, the system examines the present data and continually and dynamically makes decisions on how the information will be processes in order to validate the conversion. Accordingly, in step 106, the rules engine determines whether a data element has been fully validated as clean data. If so, the data is forwarded in step 108 to an operational database for subsequent use in the application processing. However, if it is determined that the data is not sufficiently clean, it is next determined in step 110 whether more information is required or whether there is a problem with the raw data. In either case, an exception message is generated in step 112 which must be resolved prior to the data being forwarded to the operational database. This exception message may be a request to gather more medical information, or it could be as simple as a request to fix an incorrect zip code or other erroneous data element.

In step 114, it is determined whether the exception message may be resolved automatically. For example, if we need to request a motor vehicle record, the system will automatically contact a supplier of these records and have one transmitted electronically. If the exception is resolved automatically, the information is then deemed clean and forwarded to the operational database in step 116. However, if the exception cannot be handled automatically, a associated task is sent to a person to have it resolved in step 118. Following human resolution, the data is forwarded to the operational database for subsequent processing.

In an alternative embodiment of the present invention multiple operational databases may be maintained in combination with single or multiple raw databases. Such a scheme may be implemented in scenarios where common raw data is used for different end purposes. For example different types of insurance lines such as automotive versus life—the clean data model may be completely different, but the initial data sources are the same.

In accordance with one embodiment of the present invention, a state machine and a rules engine are utilized to enhance the processing and exception handling aspects of the application process. Generally speaking, the state machine is similar to a traffic control system in that it decides who does what and when. Additionally, the state machine also controls the overall flow of information through the system. The rules engine, contrarily, includes a more specific set of procedures to check for certain conditions and, based on the results, make decisions regarding information flow and exception handling. The state machine and rules engine preferably work in combination, with the state machine directing information to the appropriate rules engine decision point. Additionally the state machine determines such things as what procedures can be completed manually and which ones can be automated. Upon making such determinations, the data may be routed to an appropriate process.

Although the present application discusses the use of the state machine in the processing of life insurance applications, its benefits may also be obtained in other industries. More specifically, such technology would be applicable anywhere work needs to be routed based on certain criteria. For example a credit card company could use the state machine of the instant invention to determine which of multiple processes to utilize for electronic credit card applications. Some applications requesting high limits might use one set of rules that requires an underwriter to examine the application, whereas smaller credit limits could be processed and approved electronically.

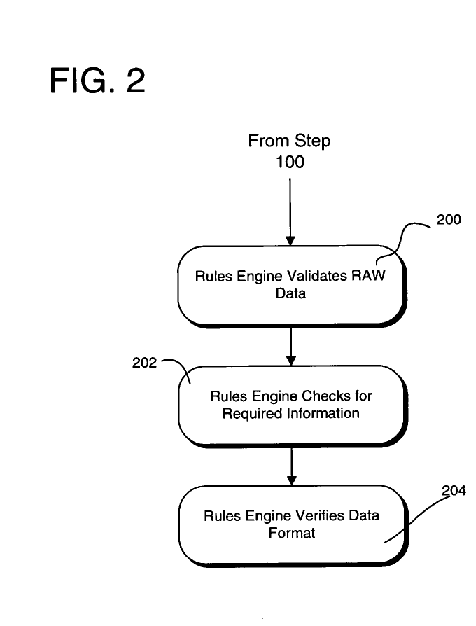

In one embodiment of the present invention, the rules engine includes a set of procedures which are used to do such things as validate data and make decisions based on that data. Each rule is composed of a set of conditions, which if met, cause a set of actions to happen. Referring now to FIG. 2, there is shown a flow diagram illustrating rules engine processing steps in accordance with one embodiment of the present invention. Initially, the rules engine manifests itself during step 100 of the general process set forth in FIG. 1. In particular, once imported in step 100 the rules engine is used to validate keyed or electronic data in the “RAW” database in step 200 to ensure its syntax is correct. Next, the rules engine checks to ensure required information is present in step 202 and that data is formatted properly in step 204. In one embodiment of the present invention, the rules engine is also utilized to make decisions based on predefined business processes. For example where to send a high dollar value case, etc.

The “Rules Engine”, as generally described above, is used in several areas of the present invention. Initially, at the point of data entry and scrubbing the rules engine is used to validate every field on a document that has been entered into the system as in steps 104 and 106 of FIG. 1. This validation step verifies whether that field is blank, altered, unreadable, as well as whether it includes proper values or data types (i.e., metadata about the fields). Based upon the results, if the data is proper, then it can move to the clean or operational database as in step 108 above. If not, then tasks are created for people (internal and external as necessary) to correct the problem. In addition to data validation, the rules engine is also used is areas such as case processing. For example, the rules engine is utilized to verify whether an originating agent is licensed to sell insurance in a certain state. If they're not, it will generate a task to get this agent licensed.

Once scrubbed, data in the operational database reflects all usable data elements received from all documents related to a ‘case’, and it is no longer important which document the data element came from. Instead, the data now revolves around a “case”. In a preferred embodiment of the present invention, the operational database is continually updated with new information about a case as documents arrive and move from the RAW database through processing and into the operational database. Returning now to FIG. 1, in step 120 the system determines whether all required information has been received into the operational database and the case is finalized. If not, the system returns to step 100 where additional information is received and the overall process is repeated. In this manner, each time new information comes in, the rules engine analyzes the data to determine if that case can be finalized. As above, various types of exceptions may be created to resolve problems. Once everything is at the point that the case can be finalized, then the case goes to it's proper end state, whether the result is application approval or decline.

By processing received data and workflow timing in a dynamic manner as set forth above, the process does not stop while the process waits on required information as is typical in conventional application processing systems. If the system cannot get the information it needs immediately, it will issue an exception and move on to the next task. When that exception has been resolved, the system will continue on from where it left off.

Additionally, the specific advantages of having the two-database concept of an initial RAW database and a scrubbed operational database is that operational database only includes information that is complete and ready to be processed. Accordingly, by enabling only clean and fully processed data to proceed to the operational database, manual processing and the affiliated errors in the final data are significantly reduced.

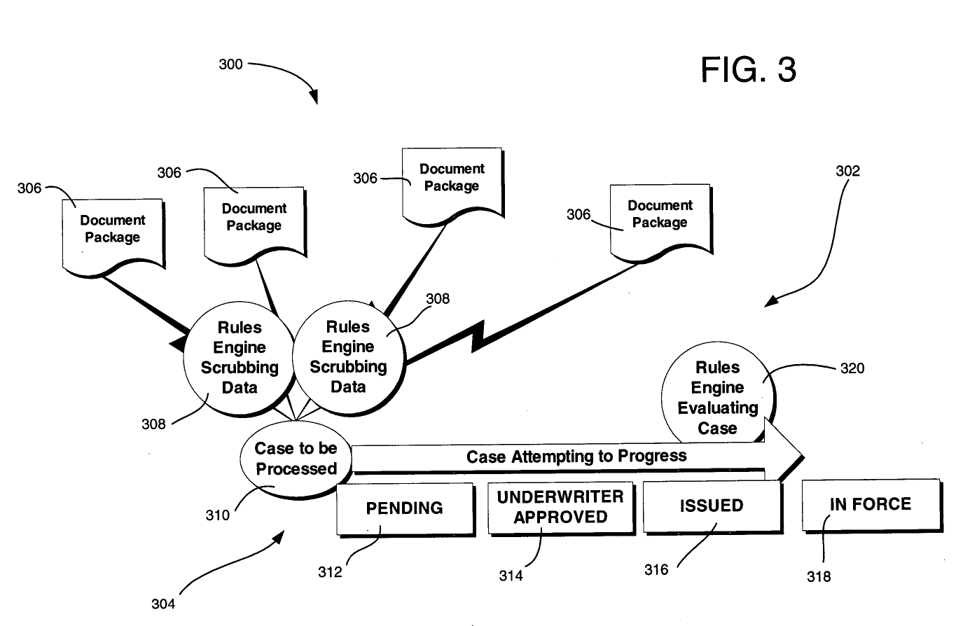

Referring now to FIG. 3, there is shown a generalized block diagram illustrating an alternative view of the information routing and processing system 300 of the present invention. As shown in the Figure, system 300 includes a data-centric portion 302 and a case-centric portion 304. Regarding the data-centric portion 302, a plurality of document packages 306 are received during the course of application processing as part of the initial application materials or in response to various exception tasks issued during processing. Once received, the document packages are validated and formatted in the manner set forth above by the rules engine 308.

Turning to the case-centric portion of FIG. 3, it can be seen that a given case includes the processing, analysis and review of various documents in case-ready format 310 as it progresses from inception or pending status 312, through approval 314, issuance 316 and finally to in force status 318. As the case proceeds, the rules engine 320 continually reviews the data available in case-ready format for potential exceptions which prohibit case progress. Because data acquisition and formatting continues somewhat irrespective of case progress, delays in information receipt are substantially less likely to cause problems with case progress. Correspondingly, increased case progress efficiency is experienced.

Additional embodiments of the present invention incorporate enabling various marketing and sales agencies, such as Insurance Agents, brokers and Reinsurers to participate as ‘exception’ handlers, and information gatherers. Furthermore, in one embodiment, a third discrete database may be implemented for enabling real-time statistical analysis/reporting/data mining.

Various aspects of the present invention allow separate computer systems to function together in various combinations. For example, a data entry system may interact with a data processing system on different platforms. Although this concept may revolve around asynchronous processing and around platform agnostic features, the software systems involved may be very much unrelated. For example, the document data entry system may be visual basic running with Optical Character Recognition (OCR) and residing on desktops, which may involve performing the data collection and saving, yet the data processing system may be performed on a mainframe picking up this information to process, which may involve performing the data retrieval and processing.

Accordingly, the various embodiments described herein demonstrate the technical effect of efficiently manipulating data flow so as to minimize the duration of the insurance application process. Maintaining distinct raw and operational databases enables efficient historical review of application documents as well as access to more usable operational and verified data. Furthermore, by enabling workflow decisions to be made on data as it becomes operational, the entire application process to advance more accurately and efficiently.

According to an embodiment of the invention, the systems and processes described in this invention may be implemented on any general or special purpose computational device, either as a standalone application or applications, or even across several general or special purpose computational devices connected over a network and as a group operating in a client-server mode. According to another embodiment of the invention, a computer-usable and writeable medium having a plurality of computer readable program code stored therein may be provided for practicing the process of the present invention. The process and system of the present invention may be implemented within a variety of operating systems, such as a Windows® operating system, various versions of a Unix-based operating system (e.g., a Hewlett Packard, a Red Hat, or a Linux version of a Unix-based operating system), or various versions of an AS/400-based operating system. For example, the computer-usable and writeable medium may be comprised of a CD ROM, a floppy disk, a hard disk, or any other computer-usable medium. One or more of the components of the system or systems embodying the present invention may comprise computer readable program code in the form of functional instructions stored in the computer-usable medium such that when the computer-usable medium is installed on the system or systems, those components cause the system to perform the functions described. The computer readable program code for the present invention may also be bundled with other computer readable program software. Also, only some of the components may be provided in computer-readable code.

Additionally, various entities and combinations of entities may employ a computer to implement the components performing the above-described functions. According to an embodiment of the invention, the computer may be a standard computer comprising an input device, an output device, a processor device, and a data storage device. According to other embodiments of the invention, various components may be computers in different departments within the same corporation or entity. Other computer configurations may also be used. According to another embodiment of the invention, various components may be separate entities such as corporations or limited liability companies. Other embodiments, in compliance with applicable laws and regulations, may also be used.

According to one specific embodiment of the present invention, the system may comprise components of a software system. The system may operate on a network and may be connected to other systems sharing a common database. Other hardware arrangements may also be provided.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications and equivalent arrangements.

1. A system for routing and processing insurance related data, the system comprising:
a data entry operator that receives insurance application-related documents from external sources,
the data entry operator stores the documents electronically in a raw data database;
a rules engine that converts the documents into at least one data element having a common format;
the rules engine determines whether each of the at least one data element has been fully validated as clean data;
the clean data is stored in an operational database for use in application processing;
the rules engine generates an exception task if it is determined that at least one data element is not clean; and
the rules engine receives a resolution to the exception task, thereby enabling validation of the at least one data element.

2. The system of claim 1, wherein the common format is extensible Markup Language.

3. The system of claim 1, further comprising:
a state machine that monitors clean data in the operational database and rules engine outputs,
wherein the state machine generates workflow tasks to enable case progression through the system, the tasks based upon said clean data and rules engine outputs,
wherein the state machine receives responses to said workflow tasks, and
wherein the state machine determines case progression based upon said responses.

4. The system of claim 1, further comprising:
a state machine that monitors data converted by the rules engine,
wherein the state machine generates data tasks to enable data verification,
wherein the state machine receives responses to said data tasks, and
wherein the state machine verifies data for forwarding to the operational database based upon said responses.

5. The system of claim 1, wherein application-related documents include electronic documents and paper documents.

6. The system of claim 1, wherein the documents of a first type are stored in a first raw data database and documents of a second type are stored in a second raw data database.

7. The system of claim 1, wherein the exception task instructs a person to perform a task to resolve the exception.

8. The system of claim 1, wherein the exception task instructs an automated process to perform a task to resolve the exception.

9. The system of claim 1, further comprising:
the rules engine determines if additional information is required to validate a data element; and
the rules engine generating an exception task to obtain the additional information.

10. A system for routing and processing insurance related data, the system comprising:
a data entry operator that receives insurance application-related documents from external sources,
the data entry operator stores the documents electronically in a raw data database;
a rules engine that converts the documents into at least one data element having a common format;
the rules engine determines whether each of the at least one data element has been fully validated as clean data;
the clean data is stored in an operational database for use in application processing;
a state machine that monitors clean data in the operational database and rules engine outputs,
wherein the state machine generates workflow tasks to enable case progression through the system, the tasks based upon said clean data and rules engine outputs,
wherein the state machine receives responses to said workflow tasks, and wherein the state machine determines case progression based upon said responses.

11. The system of claim 10, wherein
the rules engine generates an exception task if it is determined that at least one data element is not clean; and
the rules engine receives a resolution to the exception task, thereby enabling validation of the at least one data element.

12. A method for routing and processing insurance related data, comprising:
receiving insurance application-related documents from external sources,
storing the documents electronically in a raw data database;
converting, by a rules engine, the documents into at least one data element having a common format;
determining whether each of the at least one data element has been fully validated as clean data;
storing clean data in an operational database for use in application processing;
generating an exception task if it is determined that at least one data element is not clean; and
receiving a resolution to the exception task, thereby enabling validation of the at least one data element.

13. The method of claim 12, wherein the common format is eXtensible Markup Language.

14. The method of claim 12, further comprising:
monitoring clean data in the operational database and rules engine outputs,
generating workflow tasks to enable case progression through the system, the tasks based upon said clean data and rules engine outputs,
receiving responses to said workflow tasks, and
determining case progression based upon said responses.

15. The method of claim 12, wherein the exception task instructs a person to perform a task to resolve the exception.

16. The method of claim 12, wherein the exception task instructs an automated process to perform a task to resolve the exception.

17. The method of claim 12, further comprising:
determining if additional information is required to validate a data element; and
generating an exception task to obtain the additional information.

18. A computer-readable medium incorporating instructions for routing and processing insurance related data, comprising:
one or more instructions for receiving insurance application-related documents from external sources,
one or more instructions for storing the documents electronically in a raw data database;
one or more instructions for converting, by a rules engine, the documents into at least one data element having a common format;
one or more instructions for determining whether each of the at least one data element has been fully validated as clean data;
one or more instructions for storing clean data in an operational database for use in application processing;
one or more instructions for generating an exception task if it is determined that at least one data element is not clean; and
one or more instructions for receiving a resolution to the exception task, thereby enabling validation of the at least one data element.

19. A computer-readable medium incorporating instructions for routing and processing insurance related data, comprising:
one or more instructions for receiving insurance application-related documents from external sources,
one or more instructions for storing the documents electronically in a raw data database;
one or more instructions for converting, by a rules engine, the documents into at least one data element having a common format;
one or more instructions for determining whether each of the at least one data element has been fully validated as clean data;
one or more instructions for storing clean data in an operational database for use in application processing;
one or more instructions for monitoring clean data in the operational database and rules engine outputs,
one or more instructions for generating workflow tasks to enable case progression through the system, the tasks based upon said clean data and rules engine outputs,
one or more instructions for receiving responses to said workflow tasks, and
one or more instructions for determining case progression based upon said responses.

20. The system of claim 19, further comprising:
one or more instructions for generating an exception task if it is determined that at least one data element is not clean; and
one or more instructions for receiving a resolution to the exception task, thereby enabling validation of the at least one data element.
